(19) United States
(12) Patent Application Publication
(10) Pub. No.: US 2026/0006221 A1
(43) Pub. Date: Jan. 1, 2026

(54) PARALLEL SLICE ENCODING ACROSS GPUS WITH PREDICATED MULTI-REFERENCE IMAGE

(71) Applicant: ATI TECHNOLOGIES ULC, MARKHAM (CA)

(72) Inventors: Sonu THOMAS, Markham (CA); Arun Bhaskaran NAIR, Markham (CA); Kurian THOMAS, Markham (CA)

(21) Appl. No.: 18/758,250

(22) Filed: Jun. 28, 2024

(51) Int. Cl. H04N 19/174; H04N 19/105; H04N 19/167; H04N 19/196; H04N 19/436; H04N 19/573

(52) U.S. Cl. CPC H04N 19/174; H04N 19/105; H04N 19/167; H04N 19/196; H04N 19/436; H04N 19/573

(57) ABSTRACT

A processing system employs at least two graphics processing units (GPUs) to encode video. The GPUs employ sets of predicated values that indicate when reconstructed slices have been transferred between the GPUs. Furthermore, each GPU maintains a set of previous reference images, and encodes video slices based on the previous reference images having an expected predicated value. This allows each GPU to identify which reference images to use for encoding. This in turn allows the processing system to encode video frames without synchronization of the GPUs, while maintaining the quality of the encoded video.

### BACKGROUND

To reduce the overall amount of data needed to transfer images (e.g., a video stream), a processing device can employ video compression, wherein the images are encoded based on a specified image coding format. To enhance overall processing efficiency, some processing systems employ at least two graphics processing units (GPUs) to encode the video data. For example, some processing systems employ multiple GPUs such that each GPU encodes a slice (i.e., a portion) of each frame of a video stream. However, for at least some image coding formats, this division of processing between GPUs can negatively impact the quality of the encoded images, the encoding performance, or both.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system configured to encode images by dividing the encoding between at least two graphics processing units in accordance with some embodiments.

FIG. 2 is a block diagram illustrating transfer of slices of video frames between two GPUs during encoding in accordance with some embodiments.

FIG. 3 is a flow diagram illustrating a first part of a method for encoding images on two GPUs in accordance with some embodiments.

FIG. 4 is a flow diagram illustrating a second part of the method of FIG. 3 for encoding video on two GPUs in accordance with some embodiments.

FIG. 5 is a block diagram of a processing system that implements a video encoding system using multiple GPUs and predicated values in accordance with some embodiments.

### DETAILED DESCRIPTION

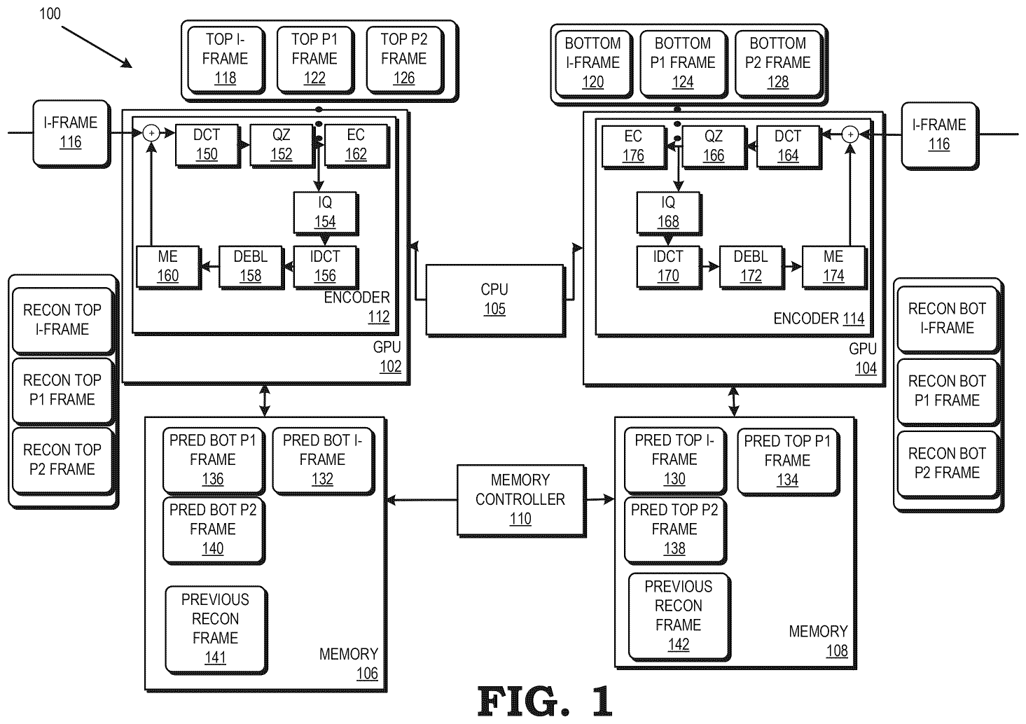

FIGS. 1-5 illustrate systems and techniques for encoding a video stream in a processing system with at least two graphics processing units (GPUs). The GPUs employ sets of predicated values which indicate when reconstructed slices of frames of the video stream have been transferred between the GPUs. Furthermore, each GPU maintains a set of previous reference frames, and encodes subsequent frames based on the previous reference frames having slices associated with an expected predicated value. This allows each GPU to identify which reference frames to use for encoding (e.g., which frames to use for motion estimation). This in turn allows the processing system to encode frames without synchronization of the GPUs, while maintaining the quality of the encoded video.

To illustrate, encoding frames on at least two GPUs provides an improvement to encoding performance over a single GPU due to both an increase in processing power and allowing the concurrent encoding of portions of a frame. Accordingly, in some embodiments a processing system employs two GPUs to encode each frame of a set of video frames, such that a first GPU encodes a first slice of each frame (e.g., an input frame) and a second GPU encodes a second slice of the same frame. However, dividing the encoding of each frame in this way presents a challenge for some video codecs. For example, some video codecs employ motion estimation, wherein the video codec identifies matching blocks of pixels between a reconstructed (that is, encoded and decoded) current frame and a previous reference frame, and encodes the current frame based on an identified motion between the matching blocks. Encoding slices of a frame at different GPUs presents challenges to these motion-estimating video codecs when, for example, the motion of a given block traverses over different slices being encoded at different GPUs. Conventionally, this situation is addressed by, for example, synchronizing the encoding operations of the different GPUs. This allows each GPU to provide its corresponding encoded slice of a given frame to the other GPU, in synchronized fashion, so that each GPU is able to perform motion estimation using the fully reconstructed frame. However, synchronizing the GPUs in this way has a negative impact on encoding performance, because each GPU must ensure that the other GPU has completed encoding of a corresponding slice before proceeding to encode the next frame. Other conventional processing systems address this motion estimation issue by having each GPU perform motion estimation only within the slices being encoded by the GPU, but this approach negatively impacts the quality of the motion estimation process, and therefore negatively impacts both the quality of the encoded image and the efficiency of the encoding.

To maintain the performance advantage of multiple GPUs and support the quality of encoding video as a single GPU, using the techniques described herein, a processing system employs a set of predicated values that identify which of a set of reference frame slices are available for each GPU to use for encoding. This allows each GPU to encode corresponding slices of a set of video frames based on a full reference frame, but without synchronizing encoding operations with other GPUs. For example, in some embodiments, each GPU includes a memory controller that sends a copy of a corresponding slice of the reconstructed frame to a memory device associated with the other GPU followed by a predicated value update to the memory device. The update to the predicated value indicates that the corresponding slice is available to be used to reconstruct a corresponding frame, allowing the reconstructed frame to be used for encoding operations, such as motion estimation. When encoding a frame slice, each GPU identifies, based on the predicated value, the most recent reconstructed frame that is available for use in encoding operations, and employs the identified frame for encoding.

To illustrate via an example, in some embodiments, an encoder of the first GPU receives an input frame (e.g., an I-frame) and encodes a first slice of the input frame. In addition, the encoder of the first GPU decodes the first slice to generate a reconstructed first slice of the input frame. Similarly, the encoder of the second GPU receives the input frame, encodes a second slice of the input frame, and decodes the second slice to generate a reconstructed second slice of the input frame. To facilitate reconstruction of the frame by the encoders of the GPUs, the memory controller copies the first slice of the reconstructed frame to a memory device associated with the second GPU and copies the second slice of the reconstructed frame to a memory device associated with the first GPU. In response to copying the slices of the reconstructed frame, the memory controller sets a first predicated value in the memory device associated with the second GPU and a second predicated value in the memory device associated with the first GPU. Each predicated value indicates whether encoding and storage of the corresponding slice of the reconstructed frame was completed by the corresponding GPU. In subsequent encoding operations, such as encoding of the subsequent frame of the video, the encoder of each GPU checks the predicated value on the memory device associated with the GPU and determines whether the most recent reference slice (that is, the most recent slice associated with a reference frame) has a predicated value that indicates the slice was encoded and is available at the corresponding memory device. If so, the GPU constructs the reference frame using the most recent reference slice. However, if the predicated value indicates that the other GPU has not completed encoding and storage of the corresponding slice of the most recent frame, the encoder of the GPU retrieves a previously reference frame and employs the previous reference frame for encoding operations, such as motion estimation. The predicated values thus allow each GPU to encode a corresponding slice of a frame without waiting for the other GPU to complete encoding of a slice of a previous frame. That is, the GPUs are able to encode slices of frames, and in particular perform motion estimation, without synchronization of the GPUs, thereby improving encoding efficiency while maintaining a relatively high level of encoding quality.

FIG. 1 illustrates a block diagram of a processing system 100 for encoding video on two graphics processing units in accordance with some embodiments. The processing system 100 is generally configured to execute sets of instructions (e.g., computer programs) in order to carry out operations, as specified by the sets of instructions, on behalf of an electronic device. Accordingly, in different embodiments, the system 100 is part of any one of electronic devices, such as a desktop computer, a laptop computer, a server, a smartphone, a tablet, a game console, and the like.

In order to execute instructions, the processing system 100 includes a first graphics processing unit (GPU) 102, a second GPU 104, a first memory device 106, a second memory device 108, and a memory controller 110. In the depicted example, the processing system 100 includes two GPUs, two memory devices, and a single memory controller. However, it will be appreciated that in other embodiments, the processing system 100 includes more GPUs, more memory controllers, and less or more memory devices. In addition, in other embodiments, the processing system 100 includes additional circuitry that supports the execution of instructions, such as a central processing unit (CPU) 105, and other circuitry not illustrated at FIG. 1, such as one or more memory buses, one or more input/output controllers, one or more input/output devices, and the like, or any combination thereof. In some embodiments, the GPU 102, the GPU 104, the first memory device 106, the second memory device 108, and the memory controller 110 are part of the same integrated circuit (IC) package, but are incorporated in separate IC dies.

The CPU 105 is generally configured to execute sets of instructions for the processing system 100. In some embodiments, the CPU 105 includes one or more processor cores, wherein each processor core includes one or more instruction pipelines. Each instruction pipeline includes circuitry configured to fetch instructions from a set of instructions assigned to the pipeline, decode each fetched instruction into one or more operations, execute the decoded operations, and retire each instruction one the corresponding operations have completed execution.

For at least some sets of instructions, the CPU 105 generates commands to be executed by one or more of the GPUs 102 and 104, such as video generation commands and video encoding commands. For example, in some embodiments each of the GPUs 102 and 104 include graphics circuitry, such as command processors, schedulers, shader processors, single instruction multiple data (SIMD) units, compute units, and the like, or any combination thereof. In response to graphics commands (e.g., draw commands) received from the CPU 105, the graphics circuitry of the GPU 102, the GPU 104, or a combination thereof, generate one or more image frames (referred to as frames for brevity) and stores the frames at, for example, one or more of the memory 106 and the memory 108.

For some applications (e.g., a video streaming application), the CPU 105 generates commands to encode image frames (e.g., a set of video frames) based on a specified video codec. To encode the video data, the GPU 102 employs a first encoder 112 and the second GPU 104 employs a second encoder 114.

In some embodiments, the first encoder 112 includes the circuitry to encode the video data, such as discrete cosine transform circuitry (DCT) 150, quantization circuitry (QZ) 152, inverse quantization circuitry (IQ) 154, inverse discrete cosine transform circuitry (IDCT) 156, deblocking circuitry (DEBL) 158, and motion estimation circuitry (ME) 160. The first encoder 112 will be described in an example implementation based on instructions to the GPU 102 received from the CPU 105 to encode video streaming data. In response to the GPU 102 receiving the video stream, the first encoder 112 receives an input frame (e.g., an I-frame 116).

The first encoder 112 employs DCT 150 as a transform technique to process the input frame by compressing data in the input frame. Specifically, DCT 150 is a type of Fourier transform (i.e., mathematical algorithm) that compresses the data in the input frame into sets of blocks, such as, for example, a block that is 8×8 pixels of the input frame. The QZ 152 then converts the compressed data from DCT 150 into a smaller set. That is, QZ 152 converts analog values supplied by the DCT 150 into digital values. Following QZ 152, the first encoder 112 reconstructs the original data through IQ 154. Additionally, IQ 154 enables the first encoder 112 to track pixel values used by the decoder (not shown) in a buffer. After the first encoder 112 reconstructs the original data, IDCT 156 further reconstructs the data by uncompressing the data in the video stream. The reason for the reconstruction is to allow the decoder to decode the data based on the encoded data. Next, the first encoder 112 employs DEBL 158 to the reconstructed video to increase quality of the video stream and improve motion prediction between the input frame and a subsequent frame in the video stream. For example, the DEBL 158 reduces artifacts (e.g., visual anomalies in the frame) by filtering block boundaries (e.g., edges of the 8×8 pixel block). The output of the DEBL 158 is thus an encoded and decoded slice, also referred to as a reconstructed slice, of the frame 116.

Finally, the first encoder 112 employs the ME 160 to identify motion vectors that shows where some pixels, if any, in the input frame move with respect to a reference frame. For example, in some embodiments, the ME 160 employs a previously reconstructed frame, sometimes referred to as a reference frame, to identify the motion vectors according to a specified motion estimation approach, wherein the reference frame is selected by the GPU 104 based on one or more predicated values indicating what frame slices have been stored by the GPU 104 and are ready to be used to form a reference frame, as described further below. The encoder 112 employs the motion vectors to encode the next received frame.

In some embodiments, the first encoder 112 further employs entropy coding (EC) 162 following the QZ 152. The EC 162 is a lossless compression based on the quantized data. The EC 162 identifies frequent patterns in the video stream and represents the patterns with a few bits and rarely occurring patterns with a relatively large number of bits. The data from the EC 162 is stored at the memory 106 as encoded video data. In some embodiments, the processing system 100 sends the encoded video data to another processing system, such as via a network, for subsequent decoding.

In some embodiments, the second encoder 114 includes the following steps to encode the video data, discrete cosine transform (DCT) 164, quantization (QZ) 166, inverse quantization (IQ) 168, inverse discrete cosine transform (IDCT) 170, deblocking (DEBL) 172, and motion estimation (ME) 174. In some embodiments, the second encoder 114 further employs entropy coding (EC) 176 following the QZ 166. For sake of brevity, description of the operation of the second encoder 114 is omitted. However, it will be appreciated that the operation of the second encoder 114 is similar to the first encoder 112 described above.

To improve performance of the processing system 100, in some embodiments the GPUs 102 and 104 are configured to each encode different portions (referred to as slices) of each input frame. That is, for each frame, the first encoder 112 encodes a first slice of an input frame (e.g., a first frame) of the video data. Moreover, the second encoder 114 encodes a second slice of the input frame of the video data, such that the second slice is different from the first slice. In some embodiments, the first slice is a top slice (e.g., a top half) of the frame and the second slice is a bottom slice (e.g., a bottom half) of the frame. In different embodiments, the first slice is a left slice (e.g., a left half) of the frame and the second slice is a right slice (e.g., a right half) of the frame. As such, the first encoder 112 and the second encoder 114 divide or separate the encoding operation (e.g., compression operation).

The first encoder 112 and the second encoder 114 each employ reference frames to generate motion vectors for the input frame. In particular, after the first encoder 112 and the second encoder 114 encode and decode a top slice and a bottom slice of a frame, respectively, the first encoder 112 and the second encoder 114 reconstruct the corresponding frame for use as a reference image in motion estimation by the ME 160. For example, in order to provide relatively accurate motion estimation, the first encoder 112 decodes the I-frame to generate a reconstructed I-frame. The first encoder 112 includes the top slice of the I-frame 118 into the reconstructed I-frame and a bottom slice of the reconstructed I-frame by the second encoder 114. In other words, the second encoder 114 decodes the I-frame to generate the reconstructed I-frame. The second encoder 114 includes the bottom slice of the I-frame 120 into the reconstructed I-frame and a top slice of the reconstructed I-frame by the first encoder 112. The reconstructed I-frame is used by each of the first encoder 112 and the second encoder 114 to perform motion estimation when encoding a subsequent frame (e.g., a P-frame).

To illustrate, in some embodiments, the memory controller 110 (e.g., a direct memory access (DMA) controller) copies the reference slices (that is, slices of a reconstructed reference frame) from each encoder 112 and 114 to the associated memory device. That is, the memory controller 110 copies the bottom slice of the reference frame in the second encoder 114 to the first memory device 106 and the top slice of the reference frame in the first encoder 112 into the second memory device 108. Furthermore, the memory controller 110 identifies whether the first encoder 112 has completed encoding and copying of the top slice of the reference frame by setting a predicated value in the second memory device 108. That is, the predicated value is a value that, when set to a specified state, indicates the availability of a corresponding slice for use in forming a reference frame. In other words, setting the predicated value refers to setting the predicated value to indicate presence in the second memory device 108 of, for example, the reconstructed top slice of the I-frame. Thus, the predicated value is used to indicate when a reference slice (that is, a slice of a frame that is to be used as a reference frame for encoding operations) has been transferred between GPUs (e.g., GPU 102 to GPU 104 or vice versa) and is available to be used for motion estimation or other encoding operations.

Similar to the first encoder 112 completing reconstruction of the top slice described above, the memory controller 110 indicates whether the second encoder 114 has completed reconstruction of the bottom slice of a reference I-frame by setting a predicated value in the first memory device 106. By setting the predicated values to indicate completion and/or availability of the top slice and/or the bottom slice, the first encoder 112 and/or the second encoder 114 receive indication of the availability for the slices for encoding and decoding of subsequent frames. In this manner, the memory controller 110 facilitates encoding of one or more subsequent frames, referred to as predicted frames (P frames).

For example, in some cases the first encoder 112 encodes a top slice of a first P frame (P1 frame) 122. The first encoder 112 checks the predicated value in the first memory device 106 to identify availability of the bottom slice of the reference I-frame. In response to finding presence of the predicated value (that is, that the predicated value has been set to a specified value), the first encoder 112 retrieves the bottom slice of the reference I-frame, reconstructs the reference I-frame using the corresponding top slice and bottom slice, and uses the reference frame to encode the top slice of the P1 frame 122. For example, the first encoder 112 employs the reference I-frame to compute one or more motion vectors that indicate movement in the P1 frame. Stated differently, the first encoder 112 uses information in the reference I-frame, to encode the motion vectors and encode the P1 frame accordingly.

However, in response to finding absence of the predicated value (that is, that the predicated value has not been set to the specified value), the first encoder 112 retrieves a previously reconstructed frame to encode the top slice of the P1 frame, such as previously reconstructed frame 141. For example, the previously reconstructed frame 141 stored in the first memory device 106 is a frame that was generated during a previous encoding of one or more frames. Stated differently, the GPUs 102, 104 maintains a set of previous reference frames, and, in response to determining that a predicated value indicates that a slice of a reconstructed frame is not available, encodes video slices based on previously reconstructed reference frames 141 and 142 respectively. Accordingly, GPUs 102, 104 employ the predicated values to identify which reference images to use for encoding, such that the first encoder 112 and the second encoder 114 encode video frames without synchronization of the GPUs, while maintaining the quality of the encoded video. As such, the first encoder 112 continues the encoding process without delay and/or waiting for synchronization with the second encoder 114 for encoding of frames.

Similar to the above process, the second encoder 114 encodes a bottom slice of the P1 frame 124. The second encoder 114 checks the predicated value in the second memory device 108 to identify availability of the top slice of the reconstructed I-frame. In response to finding presence of the predicated value, the second encoder 114 retrieves the top slice of the reconstructed I-frame to generate the full reconstructed I-frame. Moreover, the second encoder 114 computes one or more motion vectors to identify movement in the P1 frame, such as, for example, the bottom half of the football traveling away from the hand of the quarterback. Stated differently, the second encoder 114 uses information in the previous frame, the reconstructed I-frame, to encode the motion vectors and encode the P1 frame accordingly. Unlike the encoding process for the I-frame, the P1 frame requires less data to be encoded because the second encoder 114 at least partially includes the frame data from the I-frame to encode the P1 frame. The second encoder 114 reuses at least some of the frame data from the I-frame that has not changed in the P1 frame but includes any changes in the P1 frame. However, in response to finding absence of the predicated value, the second encoder 114 retrieves a previously reconstructed frame to encode the bottom slice of the P1 frame 124. For example, the second encoder 114 retrieves the previously reconstructed frame stored in the second memory device 108 during a previous encoding of one or more frames. As such, the second encoder 114 continues the encoding process without delay and/or waiting for synchronization with the first encoder 112 for encoding of frames. Accordingly, the quality and efficiency of encoding video on the GPUs 102, 104 is improved.

In some embodiments, the memory controller 110 copies the reconstructed P1 slices from each encoder into the associated memory device. To illustrate, the memory controller 110 copies the bottom slice of the reconstructed P1 frame in the second encoder 114 into the first memory device 106 and the top slice of the reconstructed P1 frame in the first encoder 112 into the second memory device 108. Furthermore, the memory controller 110 identifies whether the first encoder 112 has completed reconstruction of the top slice of the P1 frame 122 by flagging a predicated value in the second memory device 108. Similarly, the memory controller 110 identifies whether the second encoder 114 has completed reconstruction of the bottom slice of the P1 frame 124 by flagging a predicated value in the first memory device 106. By flagging the predicated values to indicate completion and/or availability of the top slice and/or the bottom slice, the first encoder 112 and/or the second encoder 114 receive indication of the availability for the slices for forming reference frames to be used for encoding and decoding of subsequent frames.

To further illustrate, the first encoder 112 encodes a top slice of a second P frame (P2 frame) 126. The first encoder 112 checks the predicated value in the first memory device 106 to identify availability of the bottom slice of the reconstructed P1 frame. In response to finding presence of the predicated value, the first encoder 112 retrieves the bottom slice of the reconstructed P1 frame to form a reference P1 frame and uses the reference P1 frame to encode the top slice of the P2 frame 126. However, in response to finding absence of the predicated value, the first encoder 112 retrieves the bottom slice of a previously reference frame to encode the top slice of the P2 frame 126. For example, the first encoder 112 retrieves the reference I-frame stored in the first memory device 106 during the previous encoding described above with respect to the I-frame. As such, the first encoder 112 continues the encoding process without delay and/or waiting for synchronization with the second encoder 114 for encoding of frames.

Similar to the first encoder 112 with respect to the top slice, the second encoder 114 encodes a bottom slice of the P2 frame 128. The second encoder 114 checks the predicated value in the second memory device 108 to identify availability of the top slice of the reconstructed P1 frame. In response to finding presence of the predicated value, the second encoder 114 retrieves the top slice of the reference P1 frame, forms the reference P1 frame using the top slice and the previously encoded bottom slice, and encodes the bottom slice of the P2 frame 128 using the reference P1 frame for motion estimation. Stated differently, the second encoder 114 uses information in the previous frame, the reference P1 frame, to encode the motion vectors and encode the P2 frame accordingly. However, in response to finding absence of the predicated value, the second encoder 114 retrieves the top slice of a previous reference frame to encode the bottom slice of the P2 frame 128. For example, the second encoder 114 retrieves the reference I-frame stored in the second memory device 108 during the previous encoding described above with respect to the I-frame. As such, the second encoder 114 continues the encoding process without delay and/or waiting for synchronization with the first encoder 112 for encoding of frames. Accordingly, the quality and efficiency of encoding video on the GPUs 102, 104 is improved.

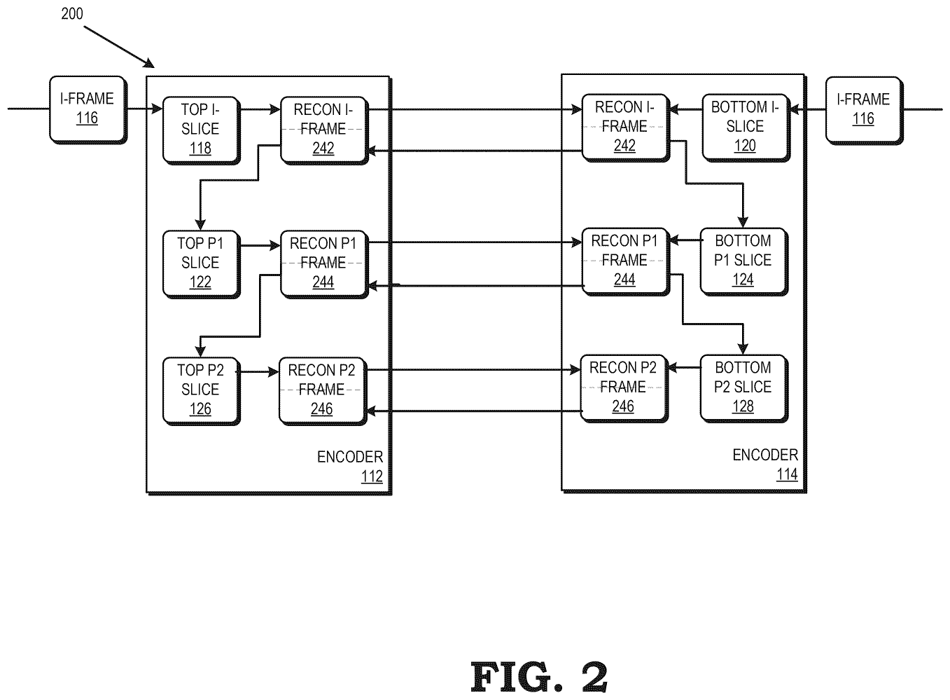

FIG. 2 illustrates an example of a processing system 200 transferring slices of video frames between the first encoder 112 and the second encoder 114 in accordance with some embodiments. The processing system 200 may be implemented by aspects of the processing system 100 as described with reference to FIG. 1. For ease of description and understanding, one or more components are omitted, including the first memory device 106, the second memory device 108, and the memory controller 110. It will be appreciated that while the aforementioned components are not illustrated, those components still perform the same operations described above with respect to FIG. 1.

In the depicted example, the first encoder 112 receives the I-frame 116. The first encoder 112 encodes the top slice of the I-frame 116 as the top I-frame 118. Moreover, the second encoder 114 encodes the bottom slice of the I-frame 116 as the bottom I-frame 120. The first encoder 112 decodes the top I-frame 118 to generate a reconstructed top I-frame slice and the second encoder 114 decodes the bottom I-frame slice 120 to generate a reconstructed bottom I-frame slice. The encoders 112 and 114 provide the reconstructed top and bottom I-frame slices to the other encoder. Using the reconstructed top and bottom I-frame slices 118 and 120, the encoders 112 and 114 each form the reconstructed I frame 242 for use as a reference frame.

With respect to the P-frames, the first encoder 112 encodes the top slice of the P1 frame as slice 122. In some embodiments, to encode the top P1 slice 122, the encoder 112 uses the reconstructed I-frame 242 as a reference frame to generate one or more motion vectors, indicating the movement of one or more pixels between the reconstructed frame 242 and the slice 122. Similarly, the encoder 114 encodes the bottom P1 slice 124 based on the reconstructed I-frame 242. Using the reconstructed top and bottom I-frame slices 122 and 124, the encoders 112 and 114 each form the reconstructed P1 frame 244 for use as a reference frame for encoding of subsequent frame slices.

Subsequently, the first encoder 112 encodes the top P2 frame 126. To determine which reference frame to use for encoding, the first encoder 112 checks the predicated value 136 (not shown at FIG. 2) for the bottom P1 slice 124. In response to determining that the predicated value indicates that encoding of the bottom P1 slice is complete and is stored at the memory 106, the first encoder 112 retrieves the bottom slice 124 and stitches the bottom slice 124 with the top slice 122 to form the reconstructed P1 frame 244. The encoder 112 then uses the reconstructed P1 frame 244 as a reference frame to encode the top P2 frame 126. In particular, the first encoder 112 uses the reconstructed P1 frame 244 to compute one or more motion vectors for the top P2 frame 126. However, if the predicated value 136 indicates that encoding and storage of the bottom P1 slice 124 is not complete, the encoder 112 retrieves the reconstructed I-frame 242 from the memory 106 and uses the reconstructed I-frame 242 as a reference frame to encode the top P2 frame 126.

The second encoder 114 encodes the bottom P2 frame 126. To determine which reference frame to use for encoding, the first encoder 114 checks the predicated value 134 (not shown at FIG. 2) for the top P1 slice 122. In response to determining that the predicated value indicates that encoding of the top P1 slice 122 is complete and is stored at the memory 108, the second encoder 114 retrieves the top slice 122 and stitches the bottom slice 124 with the top slice 122 to form the reconstructed P1 frame 244. The encoder 114 then uses the reconstructed P1 frame 244 as a reference frame to encode the bottom P2 slice 128. In particular, the second encoder 114 uses the reconstructed P1 frame 244 to compute one or more motion vectors for the bottom P2 slice 128. However, if the predicated value 134 indicates that encoding and storage of the top P1 slice 122 is not complete, the encoder 114 retrieves the reconstructed I-frame 242 from the memory 108 and uses the reconstructed I-frame 242 as a reference frame to encode the bottom P2 slice 128.

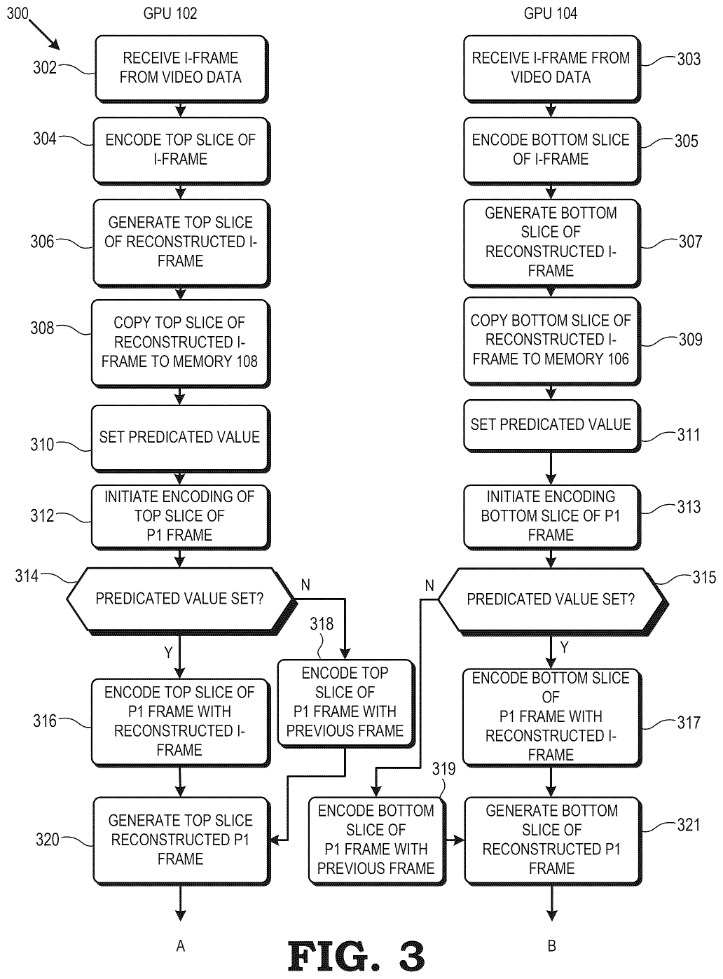

FIG. 3 illustrates a flow diagram illustrating a first part of a method 300 for encoding video in accordance with some embodiments. The method 300 is described with respect to an example implementation of the processing system 100 of FIG. 1 and the processing system 200 of FIG. 2. At block 302, the GPU 102 receives an I-frame 116. At block 303, the GPU 104 receives the I-frame 116. At block 304, the first encoder 112 encodes the top slice of the I-frame 216 as the top I-frame 118. At block 305, the second encoder 114 encodes the bottom slice of the I-frame as the bottom I-frame 120.

At block 306, the first encoder 112 decodes the encoded top slice of the I-frame 116 to generate the top slice of the reconstructed I-frame 242. At block 307, the second encoder 114 decodes encoded bottom slice of the I-frame 116 to generate the bottom slice of the reconstructed I-frame 242.

At block 308, the memory controller 110 copies the top slice of the reconstructed I-frame 242 to the second memory device 108. At block 309, the memory controller 110 copies the bottom slice of the reconstructed I-frame 242 to the first memory device 106. At block 310, the memory controller 110 sets the predicate value at the second memory device 108 for the top slice of the reconstructed I-frame to indicate that the slice is available to be used to form a reference frame. At block 311, the memory controller 110 sets the predicate value at the memory device 106 for the bottom slice of the reconstructed I-frame to indicate that the slice is available to be used to form a reference frame.

At block 312, the first encoder 112 initiates encoding of the top P1 frame 122. At block 313, the second encoder 114 initiates encoding of the bottom P1 frame 124. At block 314, the first encoder 112 checks the predicated value associated with the bottom slice of the reconstructed I-frame at the first memory device 106 to identify availability of the bottom slice of the reconstructed I-frame 242. At block 315, the second encoder 114 checks the predicated value associated with the top slice of the reconstructed I-frame at the second memory device 108. At block 316, in response to determining the predicated value indicates that the bottom slice of the reconstructed I-frame is available for encoding, the first encoder 112 retrieves the bottom slice of the reconstructed I-frame, forms a reference frame by joining the bottom slice and the top slice of the reconstructed I-frame, uses the previous reference frame to encode the top P1 frame 122, then continues to block 320. At block 317, in response to determining the predicated value indicates that the top slice of the reconstructed I-frame is available for encoding, the second encoder 114 retrieves the top slice of the reconstructed I-frame, forms a reference frame by joining the bottom slice and the top slice of the reconstructed I-frame, uses the reference frame to encode the bottom P1 frame 124, then continues to block 321.

At block 318, in response to determining that the predicated value for the bottom slice of the reconstructed I-frame indicates that the slice is not available (e.g., has not completed being generated or is not stored at the memory 106), the first encoder 112 retrieves a previous reference frame and uses the previous reference frame to encode the top P1 frame 122, then continues to block 320. At block 319, in response to determining that the predicated value for the top slice of the reconstructed I-frame indicates that the slice is not available (e.g., has not completed being generated or is not stored at the memory 108), the second encoder 114 retrieves a previous reference frame and uses the previous reference frame to encode the bottom P1 frame 124, then continues to block 321.

At block 320, the first encoder 112 decodes the top P1 frame 122 to generate the top slice of the reconstructed P1 frame 244. At block 321, the second encoder 114 decodes the bottom P1 frame 124 to generate the bottom slice of the reconstructed P1 frame 244.

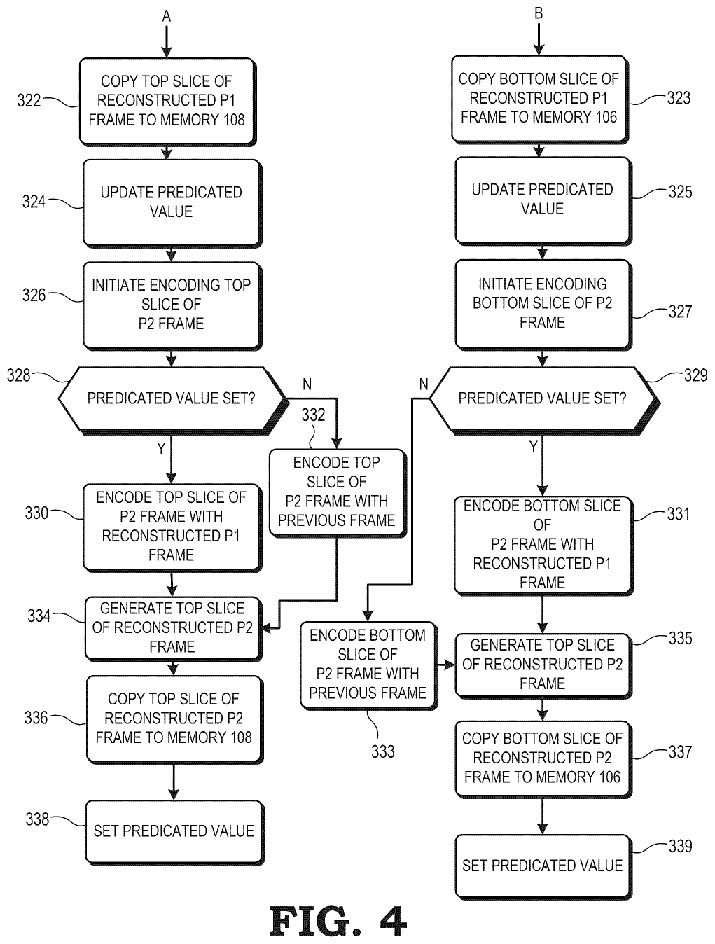

FIG. 4 illustrates a flow diagram for a second part of the method 300 of FIG. 2 for encoding video on the GPUs 102, 104 in accordance with some embodiments. At block 422, the memory controller 110 copies the top slice of the reconstructed P1 frame 244 in the first encoder 112 to the second memory device 108. At block 323, the memory controller 110 copies the bottom slice of the reconstructed P1 frame 244 in the second encoder 114 to the first memory device 106. At block 324, the memory controller 110 sets the predicate value at the second memory device 108 for the top slice of the reconstructed P1-frame to indicate that the slice is available to be used to form a reference frame. At block 325, the memory controller 110 sets the predicate value at the memory device 106 for the top slice of the reconstructed P1-frame to indicate that the slice is available to be used to form a reference frame.

At block 326, the first encoder 112 initiates encoding of the top P2 frame 126. At block 327, the second encoder 114 initiates encoding of the bottom P2 frame 128. At block 328, the first encoder 112 checks the predicated value associated with the bottom slice of the reconstructed P-frame at the first memory device 106 to identify availability of the bottom slice of the reconstructed P1 frame 244. At block 329, the second encoder 114 checks the predicated value associated with the top slice of the reconstructed P1 frame 244. At block 329, the second encoder 114 checks the predicated value associated with the at the first memory device 106 to identify availability of the bottom slice.

At block 330, in response to determining the predicated value indicates that the bottom slice of the reconstructed P1-frame is available for encoding, the first encoder 112 retrieves the bottom slice of the reconstructed P1-frame, forms a reference frame by joining the bottom slice and the top slice of the reconstructed P1-frame, uses the previous reference frame to encode the top P2 frame 122, then continues to block 334. At block 331, in response to determining the predicated value indicates that the top slice of the reconstructed P1-frame is available for encoding, the second encoder 114 retrieves the top slice of the reconstructed P1-frame, forms a reference frame by joining the bottom slice and the top slice of the reconstructed P1-frame, uses the reference frame to encode the bottom P1 frame 124, then continues to block 335.

At block 318, in response to determining that the predicated value for the bottom slice of the reconstructed P1-frame indicates that the slice is not available (e.g., has not completed being generated or is not stored at the memory 106), the first encoder 112 retrieves a previous reference frame (e.g., the reconstructed I-frame) and uses the previous reference frame to encode the top P2 frame, then continues to block 334. At block 333, in response to determining that the predicated value for the top slice of the reconstructed P1-frame indicates that the slice is not available (e.g., has not completed being generated or is not stored at the memory 108), the second encoder 114 retrieves a previous reference frame (e.g., the reconstructed I-frame) and uses the previous reference frame to encode the bottom P2 frame, then continues to block 321.

At block 334, the first encoder 112 decodes the top P2 frame 126 to generate the reconstructed P2 frame 246. The first encoder 112 includes the top P2 frame 126 into the reconstructed P2 frame 246 and a bottom slice of the reconstructed P2 frame 246 by the second encoder 114. At block 335, the second encoder 114 decodes the bottom P2 frame 128 to generate the reconstructed P2 frame 246. The second encoder 114 includes the bottom P2 frame 128 into the reconstructed P2 frame 246 and a top slice of the reconstructed P2 frame 246 by the first encoder 112.

At block 336, the memory controller 110 copies the top slice of the reconstructed P2 frame 246 in the first encoder 112 into the second memory device 108. At block 337, the memory controller 110 copies the bottom slice of the reconstructed P2 frame 246 in the second encoder 114 into the first memory device 106. At block 338, the memory controller 110 identifies whether the first encoder 112 has completed reconstruction of the top slice of the P2 frame by flagging the predicated top P2 frame 138 in the second memory device 108. At block 339, the memory controller 110 identifies whether the second encoder 114 has completed reconstruction of the bottom slice of the P2 frame by flagging the predicated bottom P2 frame 140 in the first memory device 106.

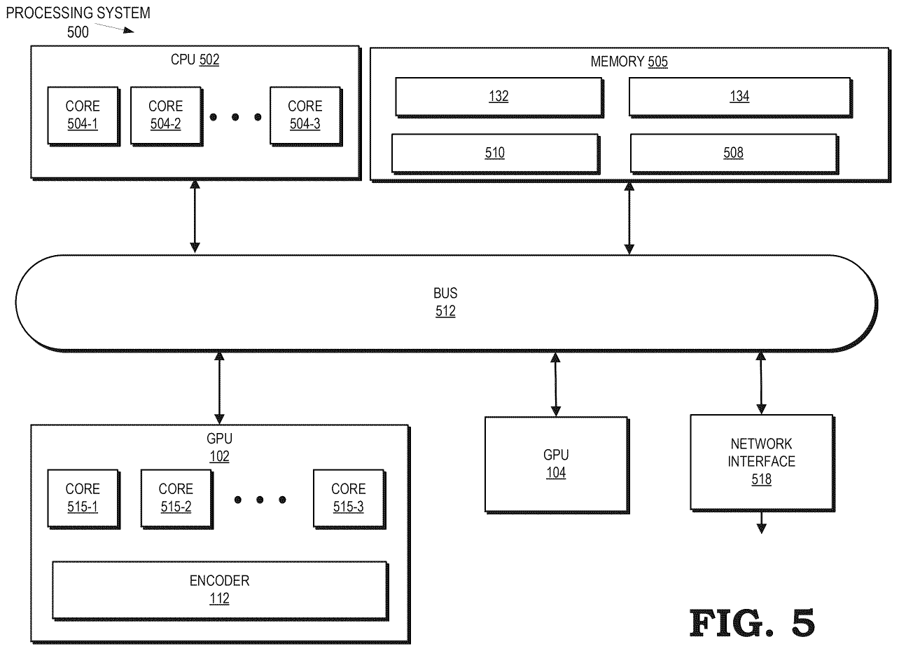

FIG. 5 illustrates an example of a processing system 500 that implements a video encoding system in accordance with some implementations. In some implementations, processing system 500 implements processing system 100 and employs multiple GPUs (GPUs 102 and 104) to encode a video stream using predicated values to indicate when corresponding images are available for video encoding operations, such as motion estimation operation. To this end, processing system 500 includes or has access to memory 505 or another storage component implemented using a non-transitory computer-readable medium, for example, a dynamic random-access memory (DRAM). However, in some implementations, memory 505 is implemented using other types of memory including, for example, static random-access memory (SRAM), nonvolatile RAM, and the like. According to some implementations, memory 505 includes an external memory implemented external to the processing units implemented in processing system 500. Processing system 500 also includes bus 512 to support communication between entities implemented in processing system 500, such as memory 505. Some implementations of processing system 500 include other buses, bridges, switches, routers, and the like, which are not shown in FIG. 5 in the interest of clarity.

The techniques described herein are, in different implementations, employed at GPUs 102 and 104. The GPUs 102 and 104 include, for example, vector processors, coprocessors, graphics processing units (GPUs), general-purpose GPUs (GPGPUs), non-scalar processors, highly parallel processors, artificial intelligence (AI) processors, inference engines, machine learning processors, other multithreaded processing units, scalar processors, serial processors, or any combination thereof. The GPUs 102 and 104 encode images, such as images that collectively form a video stream according to one or more applications 510 for streaming to one or more client devices. For example, GPU 102 and 104 together render graphics objects (e.g., sets of primitives) of a scene of a ray tracing context in a screen space (e.g., display space) to be displayed to produce values of pixels in the form of video frames, and the video frames are provided to a network interface 518 that communicates the video frames to the corresponding client devices via one or more networks. In some implementations, network interface 518 communicates with each client device via a respective network connection (not shown).

To render these graphics objects, each of the GPUs 102 and 104 includes a plurality of processor cores (e.g., cores 515-1 to 515-3 of GPU 102) that execute instructions concurrently or in parallel. For example, the APU 102 executes instructions from one or more graphics pipelines using a plurality of processor cores 515 to render one or more graphics objects. A graphics pipeline includes, for example, one or more steps, stages, or instructions to be performed by GPU 102 in order to render one or more graphics objects for a scene. As an example, a graphics pipeline includes data indicating an assembler stage, vertex shader stage, hull shader stage, tessellator stage, domain shader stage, geometry shader stage, binner stage, rasterizer stage, pixel shader stage, output merger stage, or any combination thereof to be performed by one or more processor cores 515 of GPU 102 in order to render one or more graphics objects for a scene.

In implementations, one or more processor cores 515 of GPU 102 each operate as a compute unit configured to perform one or more operations for one or more instructions received by GPU 102. These compute units each include one or more single instruction, multiple data (SIMD) units that perform the same operation on different data sets to produce one or more results. For example, GPU 102 includes one or more processor cores 515 each functioning as a compute unit that includes one or more SIMD units to perform operations for one or more instructions from a graphics pipeline. To facilitate one or compute units performing operations for instructions from a graphics pipeline, GPU 102 includes one or more command processors (not shown for clarity). Such command processors, for example, include hardware-based circuitry, software-based circuitry, or both configured to execute one or more instructions from a graphics pipeline by providing data indicating one or more operations, operands, instructions, variables, register files, or any combination thereof to one or more compute units necessary for, helpful for, or aiding in the performance of one or more operations for the instructions. Though the example implementation illustrated in FIG. 5 presents GPU 102 as having three processor cores (515-1, 515-2, 515-3) representing an arbitrary number of cores; the number of processor cores 515 implemented in GPU 102, or GPU 104, is a matter of design choice. As such, in other implementations, either GPU 102, GPU 104, or both can include any number of processor cores 515 (and each GPU can include a different number of processor cores). Some implementations of GPU 102 are used for general-purpose computing. For example, GPU 102 and GPU 104 execute instructions such as program code 508 for one or more applications 510 stored in memory 505 and GPUs 102 and 104 store information in the memory 505 such as the results of the executed instructions. Memory 505 also stores predicated values, such as predicated values 132 and 134 for use in encoding operations by the GPUs 102 and 104.

In some implementations, the GPUs 102 and 104 are configured to perform image encoding operations. To facilitate the performance of such operations, each GPU 102 and 104 includes an encoder (e.g., encoder 112 of GPU 102). In addition, each GPU 102 nd 104 is associated with (e.g., configured to communicate with) a respective command processor configured to provide data (e.g., operations, operands, instructions, variables, register files) to one or more compute units of a graphics core necessary for, helpful for, or aiding in the performance of the operations for a respective set of instructions. Because each graphics core is associated with a respective command processor configured to provide data based on a respective set of instructions, the graphics cores are enabled to render different graphics objects and encode different portions of an image at different times. That is to say, two or more GPUs are configured to concurrently encode and image such that, for example, the GPU 102 renders a first portion of an image, and the GPU 104 concurrently renders a second portion of the image different from the first portion. To encode the different portions, the GPUs 102 and 104 use predicated values to determine when a corresponding portion of an image is available to perform encoding operations, as described further herein. For example, the GPU 102 employs a predicated value to indicate when a corresponding portion of a corresponding image has been encoded and is available for processing operations. Based on the predicated value, the GPU 104 determines whether to use the portion for encoding operations, such as motion estimation, or whether to use a previously-stored reference image.

Processing system 500 also includes a central processing unit (CPU) 502 that is connected to bus 512 and communicates with the GPUs 102 and 104 and memory 505 via bus 512. CPU 502 includes a plurality of processor cores 504-1 to 504-3 that execute instructions concurrently or in parallel. Though in the example implementation illustrated in FIG. 5, three processor cores (504-1, 504-2, 504-3) are presented representing an arbitrary number of cores, the number of processor cores 504 implemented in the CPU 502 is a matter of design choice. As such, in other implementations, the CPU 502 can include any number of processor cores 504. In some implementations, the CPU 502 and GPUs 102 and 104 have an equal number of processor cores while in other implementations, the CPU 502 and GPUs 102 and 104 have differing numbers of processor cores. Processor cores 504 execute instructions such as program code 508 for one or more applications 510 stored in memory 505 and CPU 502 stores information in the memory 505 such as the results of the executed instructions. CPU 502 is also able to initiate graphics processing, including one or more encoding operations, by issuing commands (e.g., encoding commands, draw calls, and the like) to GPU 102 via bus 512.

In some embodiments, the apparatus and techniques described above are implemented in a system including one or more integrated circuit (IC) devices (also referred to as integrated circuit packages or microchips), such as the processing systems described above with reference to FIGS. 1-5. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method, comprising:
encoding, at a first graphics processing unit (GPU), a first slice of a first image and storing a first predicated value that indicates availability of the first slice; and
encoding, at a second GPU, a second slice of a second image based on the first predicated value.

2. The method of claim 1, wherein encoding the second slice comprises:
encoding the second slice using the first slice based on the first predicated value indicating the first slice is available.

3. The method of claim 2, wherein encoding the second slice comprises:
reconstructing a reference image using the first slice based on the first predicated value indicating the first slice is available.

4. The method of claim 3, wherein encoding the second slice comprises:
encoding the second slice based on the reference image.

5. The method of claim 3, wherein encoding the second slice comprises:
encoding, at the second GPU a third slice of the first image; and
reconstructing the reference image based on the first slice and the third slice.

6. The method of claim 3, wherein encoding the second slice comprises performing motion estimation based on the reference image.

7. The method of claim 2, wherein encoding the second slice comprises encoding the second slice based on a previously stored reference image based on the first predicated value indicating the first slice is not available.

8. The method of claim 1, further comprising:
encoding, at the second GPU a third slice of the first image and storing a second predicated value that indicates availability of the third slice; and
encoding, at the first GPU, a fourth slice of the second image based on the second predicated value.

9. A processing system, comprising:
a first graphics processing unit (GPU) configured to encode a first slice of a first image and store a first predicated value that indicates availability of the first slice; and
a second GPU configured to encode a second slice of a second image based on the first predicated value.

10. The processing system of claim 9, wherein the second GPU is configured to encode the second slice by:
encoding the second slice using the first slice based on the first predicated value indicating the first slice is available.

11. The processing system of claim 10, wherein the second GPU is configured to encode the second slice by:
reconstructing a reference image using the first slice based on the first predicated value indicating the first slice is available.

12. The processing system of claim 11, wherein the second GPU is configured to encode the second slice by:
encoding the second slice based on the reference image.

13. The processing system of claim 11, wherein the second GPU is configured to encode the second slice by:
encoding, at the second GPU a third slice of the first image; and
reconstructing the reference image based on the first slice and the third slice.

14. The processing system of claim 11, wherein the second GPU is configured to encode the second slice by performing motion estimation based on the reference image.

15. The processing system of claim 10, wherein the second GPU is configured to encode the second slice by encoding the second slice based on a previously stored reference image based on the first predicated value indicating the first slice is not available.

16. The processing system of claim 9, wherein:
the second GPU is configured to encode a third slice of the first image and storing a second predicated value that indicates availability of the third slice; and
the first GPU is configured to encode a fourth slice of the second image based on the second predicated value.

17. A method, comprising:
encoding, at a first graphics processing unit (GPU), a first slice of a first image and storing a first predicated value to indicate availability of the first slice;
encoding, at a second GPU, a second slice of the first image; and
performing motion estimation at the second GPU for a third slice of a second image based on the first predicated value.

18. The method of claim 17, wherein performing motion estimation comprises:
in response to the first predicated value indicating availability of the first slice, generating a reconstructed image based on the first slice and performing motion estimation based on the reconstructed image.

19. The method of claim 18, wherein performing motion estimation comprises:
in response to the first predicated value indicating unavailability of the first slice, retrieving a previously stored reference image and performing motion estimation based on the reference image.

20. The method of claim 17, further comprising:
storing a second predicated value to indicate availability of the second slice; and
performing motion estimation at the first GPU for a fourth slice of the second image based on the second predicated value.
